(19) United States
(12) Patent Application Publication
(10) Pub. No.: US 2009/0037899 A1
(43) Pub. Date: Feb. 5, 2009

(54) RADIO FREQUENCY IDENTIFICATION (RFID) NETWORK UPGRADE SYSTEM AND METHOD

(75) Inventors: Sanjeev Dharap, Palo Alto, CA (US); Anurag Mendhekar, Los Altos, CA (US); Vjay Pawar, Foothill Ranch, CA (US); Priyank Shrivastava, Sunnyvale, CA (US)

Correspondence Address: DLA PIPER US LLP, 2000 UNIVERSITY AVENUE, E. PALO ALTO, CA, 94303-2248, US

(73) Assignee: BLUE VECTOR SYSTEMS, Palo Alto, CA (US)

(21) Appl. No.: 11/869,076

(22) Filed: Oct. 9, 2007

Related U.S. Application Data
(63) Continuation-in-part of application No. 11/056,561, filed on Feb. 10, 2005, now Pat. No. 7,423,527.
(60) Provisional application No. 60/544,713, filed on Feb. 13, 2004.

(51) Int. Cl. G06F 15/173; G06F 9/445

(52) U.S. Cl. 717/173; 709/223

(57) ABSTRACT

An on-demand upgrade system and method for upgrading components of a distributed system is provided in which an upgrade notice is used.

### RELATED APPLICATION/PRIORITY CLAIM

This is application is a continuation-in-part and claims the benefit under 35 USC 120 to U.S. patent application Ser. No. 11/056,561, filed on Feb. 10, 2005, which in turn claims priority under 35 USC 119(e) and 120 to U.S. Provisional Application Ser. No. 60/544,713, filed on Feb. 13, 2004, both of which are incorporated by reference herein in its entirety.

### FIELD OF THE INVENTION

The invention relates generally to a computer-implemented system and method for managing radio frequency identification (“RFID”) networks and in particular to a system and method for deploying and managing RFID networks and processing and managing the data generated by RFID tags and other devices/sensors.

### BACKGROUND OF THE INVENTION

With the increasing proliferation of cost-efficient and powerful computing and communications capabilities comes the ability to deploy sensors and link them to a network. The benefits of this link is obvious in some areas, for example in enterprises like supply chain management (SCM). A supply chain includes manufacturing centers, transportation fleets, warehouses/distribution centers and retail/wholesale outlets. Information about goods in the retail/wholesale outlets, for example, can be obtained from a remote computer that is connected to the sensors that track the goods.

Current object tracking solutions are based on bar codes and the use of bar code readers. A bar code system requires bar codes to be in good condition and must be in the line-of-sight of the readers. The wear and tear on labels and the difficulty of guaranteeing that the label is presented appropriately to the reader are major hindrances to increased automation as they often require human intervention. Since human intervention is required during normal operation, the workers could detect and remedy incorrect or faulty operation of the devices/system. RFID technology offers a more reliable solution than bar codes and lends itself to automatic operation (i.e., with reduced human involvement) because the radio frequency technology is less sensitive to factors like the condition and the position of the sensor devices. Further, RFID can monitor devices at a higher rate than bar codes, thereby allowing an increase in the throughput of goods and services when the existing infrastructure is coupled with RFID. Since no operator is needed on site for an RFID-based operation, the operation is usually monitored from a remote terminal that is linked to the sensor device, through a data network.

A problem with the currently available RFID data network system is that information only travels in one direction, from the RFID sensors to the monitoring terminal. Thus, although the user can see that something problematic is happening, there is no method in the system for addressing the problem real-time. For example, a user may see that a package is traveling on a wrong route based on the tracking done by the RFID sensors. However, there is not much the user can do to correct the route when he sees the problem. By the time he can re-route the package, for example through a series of phone calls that eventually reach the delivery truck driver, the package may have already arrived at the wrong destination.

Although a post-mortem analysis of what happened might provide useful information for future implementation, the data would be much more useful if something could be done about a problematic event more promptly. An organized method that allows quick perception and prompt response to a complex situation is desired. Since computing power and sensor devices have become cost-effective and readily available, large numbers of sensors can be deployed to provide superior resolution. By employing the appropriate numbers of sensors and computers/networks, an infrastructure that can 1) support a large number of sensors of diverse capabilities; 2) provide easy configuration and rapid deployment and networking of the sensors; and 3) provide a simple one-stop solution to configuring and managing the sensors.

The software standards set by standards bodies, such as the Auto-ID center defined Savant based architecture, are designed to handle EPCGlobal data and form the basis of most REID solutions today. However, these solutions are unable to handle generic event data and are limited by their adherence to a narrow standard. The inflexible adherence to the standard restricts their ability to scale up to larger, more diverse implementations made up of heterogeneous sensor devices.

Since the value and the utility of the information from the sensor often reside in the relationships between the data, a solution that can deploy, manage and process data in order to extract information, and in some cases even act on the data to facilitate the business activities of the enterprise, is needed. Such a system that can interface and interact with existing systems is desired. The system is preferably agile and scalable so that it can evolve along with the changing needs of the enterprise.

### BRIEF DESCRIPTION OF THE DRAWINGS

FIG. 1 is a diagram illustrating an RFID system that may incorporate an upgrade method;

FIG. 2 is a diagram illustrating that network management computers may be connected with one another other to form a larger network;

FIG. 3 is a diagram illustrating the aspect oriented program that is part of the RFID system shown in FIG. 1;

FIG. 4 is a flow diagram depicting the compilation and code generation process performed by the AOP engine in the Network Management Computer;

FIG. 5 illustrates an exemplary sensor network on which an upgrade method may be implemented;

FIG. 6 is a flow diagram depicting an on-demand upgrade method;

FIG. 7 illustrates an example of a user interface for an upgrade demand;

FIG. 8 illustrates an example of an upgrade request; and

FIG. 9 illustrates an example of an upgrade notice.

### DETAILED DESCRIPTION OF THE EMBODIMENTS

Prior to describing the upgrade method and system, an RFID system that may implement the upgrade method is described. The RFID system is particularly applicable to monitoring and tracking of goods in a supply chain or a distribution network, starting at the manufacturer and proceeding all the way to the end customer and the system is described in the monitoring and tracking context and, specifically, in the context of a system that employs radio frequency identification (RFID) tags. It will be appreciated, however, that a system may be used in applications where the input stimuli is not necessarily the output of a sensor probing the physical environment. It can be applied to monitoring and managing stock market operations, where instead of RFID events there are stock transactions. In the stock market context, the system can monitor whether regulatory requirements are being met. In another example, the invention may be used to track travelers entering and leaving the country by scanning their documents and generating events and exceptions in accordance with whether they are adhering to travel-related laws.

A “computer,” as used herein, is intended to mean any electronic unit having a processor, a memory, and one or more portals for connecting to other devices. A “sensor” is intended to mean any device that generates a signal when a predefined condition is detected or read, and includes but is not limited to an RFID-tag sensor/reader.

The system is configured by a web-based management system that is a Graphical User Interface to a specification system based upon an Aspect-Oriented Processing Engine designed to support large-scale distributed systems. The engine consists of a specialized compile-time source-code transformation system that takes in multiple descriptions of various aspects about the system and merges these descriptions into code-images that run individually on each of the participating computers in the distributed system. These aspects include: network hierarchy (which computer is connected to what), network characteristics (what kinds of links connect the computers), physical layout (how the computers are arranged in the context of a physical deployment), functionality (what the system actually needs to do), system health (information about the state of the system), data quality (what to do to make sure that the data coming out of the system is error-free). The Aspect-oriented processing engine allows programmers to specify each of these aspects independently, allowing very rapid configuration and customization of the underlying distributed computing system. Further, the functionality aspect itself is broken up into programmer selectable sub-aspects (called behaviors) which can be combined to create complex behaviors or schema. A behavior can be used as an abstract building block of the user application. Behaviors are configurable and have parameters attached to then that then make them very flexible and applicable to a vast range of applications.

A business process or a sub-section thereof can be represented in the abstract or formally as a schema, constructed by the user using appropriate behaviors. The schema must be parsed and transformed into a logical overlay; this only requires knowledge of the building blocks and the processing dependencies and constraints. This logical overlay has to be mapped onto the network of sensors and processing nodes (physical overlay), which would require knowledge of the organization of the sensors, the routers and the network management computer nodes and the zone hierarchy mapped onto them. The drag and drop GUI allows for a quick setup and efficient scaling up of the system. With the aspect oriented programming approach, once the specifications are provided in terms of the various system aspects, the aspect oriented engine then merges the requirements to create the solution. The aspect oriented server can then distribute the code images to relevant (only for those for whom the code images have changed) components of the network. This results in a self-configuring and self-managing system once the user has specified their requirements in terms of the aspects. Should it become necessary, additional aspects can be easily added to the system.

One of the advantages of the RFID system described herein is that it allows bidirectional communication between the monitoring terminal and the sensor devices. Like in the conventional systems, sensor devices send data to the monitoring stations. In addition, the system of the invention allows users to send configuration instructions to the sensor devices to reconfigure the devices as they wish. In more detail, the computers in the network connects to and acquire data from the sensor devices, convert the data/events to business information in accordance with prescribed workflows/schemas reliably, and route them appropriately. Additionally, the system allows the sensor devices to be configured, monitored and managed from a remote location.

The system has high reliability and robust operation with the ability to recover from partial/local crashes or disruptions in the network. Given that needs and requirements evolve over time, the system provides easy re-configuration of a deployed system and modifications in its workflow/schema in support of process evolution. The system also allows a user to instrument and gather data on the performance of the system so that changes and improvements in the system can be quantified. The instrumentation and data gathering capabilities of the system are also applicable in troubleshooting and debugging.

Another advantage of the system is that it is usable with a heterogeneous mixture of sensor devices at once, unlike the currently available RFID-tag network systems. The system may include connectivity software that is capable of connecting to legacy systems and mixed equipment environments. This flexibility is especially useful when using the invention with an RFID system because RFID systems are generally applicable to a wide range of applications such as financial transaction, widgets on a production line, or regulatory requirements. The main difference between the RFID systems in these different applications is in the characteristics and types of sensor devices in the RFID system including the type of data being gathered.

The system also provides monitoring, device driver/control system diagnostics, alerts and notifications. Further, the system provides remote/on-line maintenance, upgrades, extensions, reconfiguring and/or redeployment of devices in the system. The system has self-healing capabilities such as the ability to (re)download the proper code images after a crash, and redundant mechanisms for backup. The system also has data monitoring and management capabilities that permit the system to perform data aggregation, synchronization and integration functions, real-time event monitoring, multi-protocol, format negotiations, and automated decision-making support tools. The system also has data storage, migration and resolution management tools, and application development environment/tools that allow a user to create an application. Thus, the system may include application and task authoring tools and a rich library of building blocks. The system also has device/application/system performance monitoring tools.

The invention provides a system and method for remotely monitoring and/or tracking objects and events. Unlike the currently existing solutions, the invention comprehensively addresses the requirements of rapid, large deployments, central management of resources, rich application development capabilities, streamlined operations management and flexible interfacing with legacy and partner applications. Current solutions focus on performing tasks such as interfacing with RFID readers, performing filtering operations on data, and basic management of readers but lack the ability to rapidly configure and deploy a network or provide ongoing real-time monitoring of objects.

Generally, the invention(s) presented herein allows the design of solutions where data from a variety of sensors can be collated to generate information for business processes in a seamless and uniform manner without restriction on the scale or type of operation.

System and Network Architecture

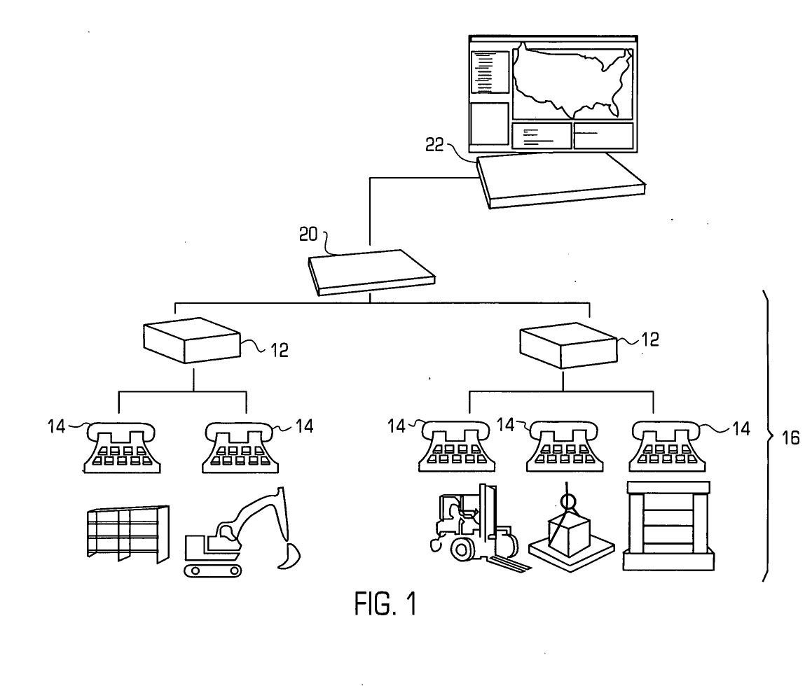

FIG. 1 is a diagram illustrating an RFID system 10 that may include an upgrade system and method. The system includes one or more RFID routers 12 that interface with one or more sensors 14. Some of the sensors 14 are coupled to a Network Management Computer 20, which controls the communication between a user interface 22 and the RFID routers 12, and ultimately between the user interface 22 and the sensors 14. The group of RFID routers 12 that are controlled by a single Network Management Computer 20 form a domain 16. The RFID reader/sensors 14 that are connected to one RFID router 12 can have varying capabilities and uses. Thus, unlike the currently available systems, the RFID router 12 can be connected to a heterogeneous mix of sensors 14 at the same time as long as the sensors 14 are capable of communicating digitally. Besides RFID sensors, the sensors 14 may be GPS devices, temperature sensors, pressure sensors, etc.

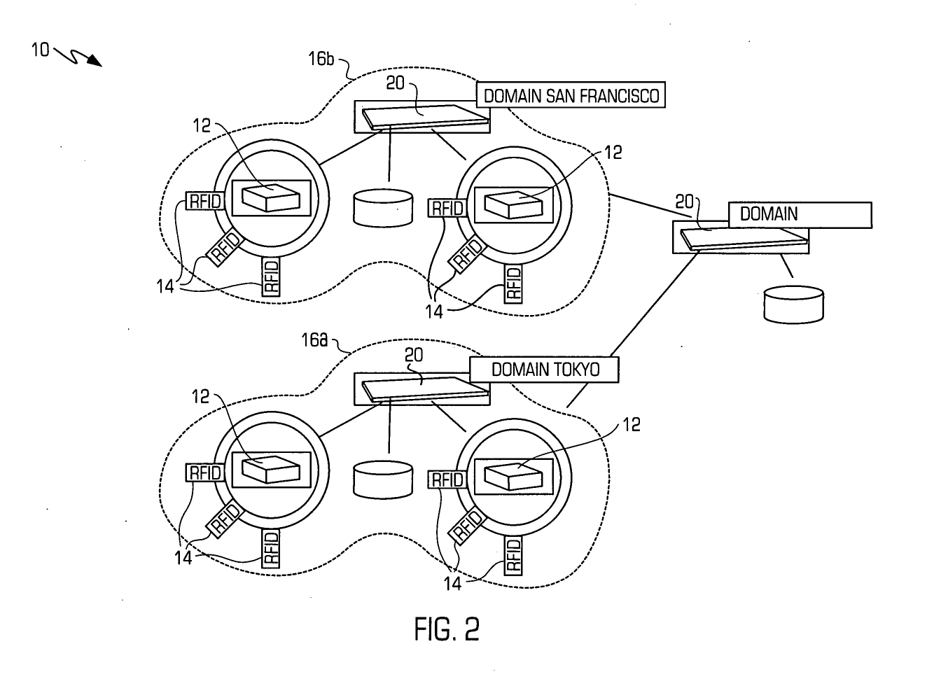

FIG. 2 illustrates that network management computers 20 may be connected with one another other to form a larger (e.g., worldwide) domain that includes all of the individual domains 16. The example shown in FIG. 1 includes a Tokyo domain 16a and a San Francisco domain 16b that are connected together to form a worldwide domain. The connections between the sensors 14 and the RFID routers 12, between the RFID routers 12 and the network management computers 20, and among different network management computers 20 need not be direct or wired connections. For example, these connections can be over the Internet. The communications between the devices mentioned above takes place by using standard, well-known internet protocols. The links between the various devices and application shown in FIG. 2 can be any type of communications link, such as wired or wireless connections or any combination of the two.

FIG. 2 illustrates that the network management computers 20 may be arranged in layers, or “zones” that are each controlled by a set of network management computers 20. The embodiment of FIG. 1 is a single-layered configuration whereby one network management computer 20 controls all the sensors 14. In contrast, in the multi-layered embodiment of FIG. 2, each domain 16a, 16b is controlled by a first layer of network management computer 20, and both of the domains 16a, 16b are controlled by a second layer of network management computer 20. Formation of zones makes it easy to control the sensors 14 because specific aspects and behaviors can be associated with particular zones. For example, in the embodiment of FIG. 2, a certain set of aspects and behaviors that are intended for the sensors 14 in Tokyo can be directed specifically to the network management computer 20 that controls the Tokyo domain 16a. The San Francisco domain 16b will remain free to be associated with its own set of aspects and behaviors.

One or more RFID routers 12 may form a domain 16 wherein the RFID routers 12 in the domain are connected to a network management computer 20. Each RFID router 12 is used to interface with, communicate and modify the configurations of sensors 14 that are connected to it. The RFID router 12 can issue commands/requests to the reader devices and the readers/devices then respond accordingly and/or the devices/sensors may asynchronously (independent of a specific command-response sequence and determined only by the configuration) communicate changes in its environment to the RFID router. In yet more detail, the RFID router 12 is a network element that can configure readers/sensor devices, monitor them, process data received from them and work in concert with the network management computer 20 to perform system operations. The RFID routers 12 come with a rich set of interconnections allowing it to interface with sensors 14 over a wide range of interconnections including but not restricted to Serial interfaces, Ethernet, and wireless. Likewise, the RFID routers 12 can communicate with the network management computer 20 using wired or wireless-interconnect.

The network management application 20 is the device through which the system is deployed and customized, and applications developed. The network management computers 20 also participate in the execution of the application and system functions. The network management computers 20 are capable of web-based management and operations using a drag-and-drop user interface for RFID configuration. It provides authentication for multi-user support. The configuration/customization features provide customizable data quality management and supports creation of new process and integration of existing business processes.

The network/system may be hierarchically partitioned into one or more zones. A zone is an aggregation unit that can include one or more devices and can have configuration parameters, conditions/operations and behaviors attached to them. The zones are used to logically partition the RFID network for purposes of structured data processing and management. The zones are hierarchically composed, i.e., a zone can be made up of other zones (sub-zones). The sub-zones cannot be split among zones. In a preferred embodiment, a zone can have only one parent zone, except when it is the root zone then it has no parent. In a preferred embodiment, there is no limit on the number of children a zone can have. The zones (along with the devices and operations) can be replicated by copying.

Workflow

The system advantageously includes a mechanism to represent a process to be performed or modeled using the system. This modeling, representation and specification are termed the schema or workflow which can be hierarchically composed. The schema is not restricted to user business processes and this is specified in terms of the parameters of the different aspects. A workflow will, in general, be a specific sequence of operations which may include one or more of the following: the detection of events and monitoring of conditions, accessing data typically by querying, performing specific tasks, producing information in specified formats and some form of notification. The sequencing of the operations or the dependency of the operations can be time constrained.

A workflow/schema is composed of a number of smaller or sub-workflows/sub-schemas. Most are generic operations but often they are special processes or flows defined by standards, industry specific regulations, etc. A number of such building blocks are encapsulated and provided for rapid mapping of the user's business process into a workflow/schema. Such building blocks are an encapsulation of a sequence of actions to be taken when preset conditions are fulfilled. This encapsulation is available as a building block to be used in the design of the overall solution. It can be represented as a collection of different aspect specifications, which is herein referred to as a Behavior. A Behavior addresses very specific tasks that a collection of aspects might be able to accomplish. A Behavior is not limited to operate on data/events produced by the readers/sensors. A Behavior can take secondary events as inputs as well as external or user input. Thus, a Behavior may be used to configure the system or parts of it. In general, a programmer can annotate the Physical Layout with Behaviors as a convenient method to accomplish frequently needed tasks. For example, a counter Behavior is simply a counter. The stimulus for the Behavior counter can be specified as a particular event (perhaps an exception event). This association can be defined through the web interface as an annotation of the Physical Layout. During operation, each time the exception takes place the counter increments. By querying the counter periodically, a log can be maintained. The Behaviors can be combined and associated in a LEGO-like fashion to construct more complicated processes.

An operation is usually triggered by an event. The primary sources of events are the readers/sensors 14. The responses from sensors 14 that are either based on a command issued to it or due to a change in the environment it is monitoring are primary events. When the sensors 14 detect changes in their environment and generate an event, the event is “intrinsic.” Every intrinsic event has a name and is associated with a zone. A sequence or combination of events create a secondary event. The parameters associated with a secondary event pertain either to the Partitioning aspect (system-defined) or to the Functionality aspect (user-defined). The two types of aspects are described below in more detail.

The appliances may be configured to monitor events or pattern of events (through the web interface) and determine whether certain conditions are fulfilled. The time ordering of events and constraints on the interval of time between events may be specified in a condition. The conditions are attached to a particular one or more zones. On generation of events in a zone, the conditions are examined by the appliances configured for that zone to determine if any action is triggered. A condition in one zone can create an event for another zone. Once a condition is satisfied, one or more operations can follow.

One of the operations may require data or state lookup for completion. This lookup process is accomplished by issuing a query to a database or other storage. The response to the query is then utilized in the operation. The query may address information in the system or third party information. Once the requisite sequence and pattern of events satisfies a condition and, if required, the subsequent information gathering completed, the system will initiate a user-specific task. On completion of a task or as part of a task, record keeping operations, status updates and state changes may be performed and notifications posted. This can take place in a number of ways.

The system will attempt to automatically compose the selected Behaviors (those pick and mapped by the drag-and-drop GUI interface) and, in case of conflicts, the user is requested to arbitrate and select the correct one. This is accomplished by the use of a Behavior attribute called the signature. The signature of a Behavior includes its input/output characteristics as well as other operational parameters. In conjunction with rules for composition based on signatures the system automatically connects the Behaviors, when they are selected and dropped onto a location, with other Behaviors at that location.

For example, consider an application where a specific dock door at a warehouse is meant only for loading paper towels. The application-developer would then drag-and-drop a filter Behavior to that location and then set the range attributes of the Behavior to those corresponding to the codes for paper towels. The developer may set up an alarm notification when paper towels are received at the dock door. In addition, one can also specify the action in case a pallet containing items other than paper towels shows up at the dock door to keep track of how often a pallet shows up incorrectly at this dock door. The developer will then select a counter Behavior and drag and drop it to the same location as the filter behavior. On specifying the type of input it must handle (in this case an alarm event), the system will automatically assign the input of the counter to receive the alarm output of the filter Behavior. Working in this manner, a much more complex system of operations can be fashioned.

Behaviors are easy to add because they do not need knowledge of the compiler modules. A library system manages different behaviors and their parameterization in order to reuse them effectively. The intention is that end-users of the system can create their own behaviors and reuse them, while new aspects are added by specialized personnel who have the expertise to determine when a new aspect should be added and how.

The architecture of the AOP system allows runtime-updates of the system. When the behavior of the distributed system is modified, a new set of compiled code images is generated from the new aspect specification. If the generated code image for a network-element is different from the previous code image, the code distribution server asks the network-element to reload the code image by sending it a reload event. This request prompts the network element to reconnect to the code-distribution server, download the code, and restart itself. In certain cases, it is possible to restart the system by maintaining runtime-information that was generated by the previous code-image. In other cases, when the changes to a zone handler are significant, this may not be possible as it would require generating new information. Both these types of restarts are permissible in the system.

Through the use of aspects and behaviors, the invention allows the creation of a business process or schema that is implemented with varying degrees of automation. Merriam-Webster defines schema to mean, “a diagrammatic presentation; broadly: a structured framework or plan” or “a mental codification of experience that includes a particular organized way of perceiving cognitively and responding to a complex situation or set of stimuli.”

The system may provide standard data processing, filtering, and ONS/PML lookup operations. In particular, generic operations include such tasks as duplicate removals when multiple readers may overlap in reading a tag, in the standards based category would fall tasks such as performing ONS/PML lookups in an EPCGlobal compliant fashion. If the workflow/schema includes having to configure parts of the system, then the tasks that gather configuration information for the infrastructure could also be provided. Similarly, Behaviors that are required to interface and communicate with other Business Information systems (implementing functionalities required by Rosseta Net, XML, SOAP among others) are included as part of the library of the web-based configuration system.

In an exemplary chain operation, an object is observed and monitored by radio frequency as it moves through the supply chain in accordance with a business plan. The sequence is to observe the object as it leaves a first observation station (e.g., manufacturer), then observe it appear at a second observation station (a distribution center or possibly one of a set of retail stores), observe it be subjected to processing at the station and, on successful conclusion of the processing, observe it move on to a third station. The choice of stations depends on the planned route selected based on the starting point and the destination.

The time delay between the manufacturer's warehouse and the distribution center may be constrained, as in an SCM pallet that has to get to its destination by a certain time. For example, the pallet may contain certain chemicals or medications with an upcoming utility expiration date, stock transaction settlement, urgently needed documents, etc. The processing at the destination can be conditional based on when it arrives, as can be its next destination (e.g., a late arriving pallet may have to be re-routed). Additionally, logs may have to be updated.

In this example, then, the first event represents the departure of the object from the first station. This event in turn triggers a condition at each of the destinations that now watches for the object's appearance at the next station. The appearance of the object at the destination will, in turn, trigger a receipt process such as billing or checking its condition. Successful completion of this receipt process will then result in it being moved to its next destination (shelf or storage) in its path. In this manner, the object moves through a chain of stations until it reaches the final station. An exception or a deviation from its prescribed plan/route anywhere along the chain can result in generation of reports, which contain information/data necessary for a follow-up and notifications being sent often with remedial actions specified. The remedial action, if any, is provided via triggering a different set of tasks/agents and may include running diagnostics, re-deploying some resources and increasing the resolution of observations around the fail point (akin to zooming in) and also, perhaps, modifying the type of observations (along new axes when possible) to get a better look at the problem.

Aspect-Oriented Program

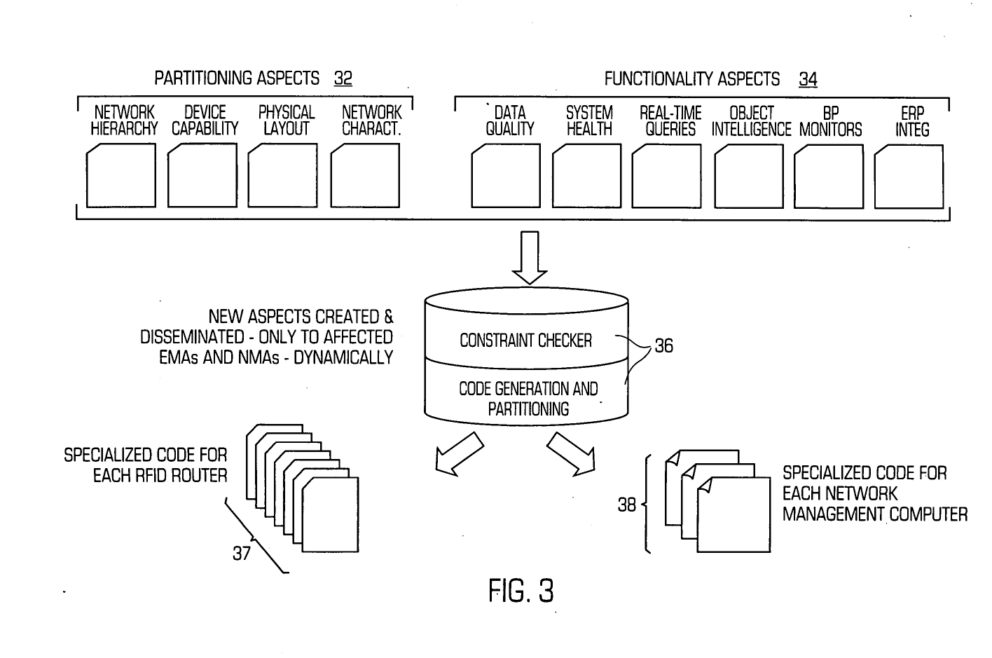

FIG. 3 is a diagram illustrating the aspect-oriented programming (AOP) 30 that may be used in the system 10 and more specifically in the network management computer 20. The AOP is responsible for the construction, execution, and coordination of a distributed system. The AOP server system consists of four key elements: AOP compilation, Distributed System Boot-up, On-going Operation, and Run-time updates. The AOP system is includes a weaver 36 that takes multiple aspect specifications and merges them into executable code for the system under development.

There are two types of Aspects: Partitioning Aspects 32 and Functionality Aspects 34. The Partitioning Aspects 32 pertain to network and hardware layout and limitations, and are not reconfigurable through the user interface 22. Partitioning Aspects include but are not limited to network hierarchy, device capability, physical layout, and network characteristic. For example, in a warehouse context, the types of sensors that are installed (device capability) and the way the sensors are wired (physical layout) are Partitioning Aspects that can only be changed by someone (e.g., an electrician) who goes to the warehouse, and cannot be changed by an input into the user interface.

When one or more sensors 14 are added to the system 10, the Partitioning aspects may have to be adjusted to incorporate the added sensors 14 unless there is already built-in support for newly added sensors 14. A sensor can also be replaced, e.g., with a different type of sensor. Thus, the sensors 14 can be plug-and-played fairly easily.

The Functionality Aspects 34, in contrast, are controlled through the user interface. Functionality Aspects 34 include but are not limited to data quality, system health, real-time queries, object intelligence, business process (BP) monitors, and enterprise resource planning system (ERP) interrogation. A weaver 36, upon receiving a user input, pulls the Partitioning Aspects that are relevant to the affected Functionality Aspects and generates appropriate code images. For example, if a user reconfigures the system to re-route a package from Route A to Route B, the weaver 36 identifies the sensors that are affected by this change by using the Partitioning Aspects, and generates code images that are directed to the affected sensors. The code images may, for example, direct certain sensors along Route A to send an alert if they detect this package (because that means the re-routing was unsuccessful), and direct certain sensors along Route B to look for the package. The code images are implemented by the RFID router 12 shown in FIG. 1.

Where there are multiple layers of NMAs as shown in the embodiment of FIG. 2, the top-level NMA generates code images not only for the network components downstream but also for itself. The portion of the code images that is generated for itself may be locally stored. In case of a crash, the code images may be retrieved from this local storage or regenerated. The top-level NMA forwards the code images that are not intended for itself to the appropriate network components.

An advantage of the AOP system is that it is user-friendly. In a conventional program, a user who wants to reconfigure the sensors would have to understand how the wires are connected before sending code images to the RFID routers 12. With the AOP system, however, a user can designate the configuration he wants, for example by moving icons on the user interface screen or typing in commands, without worrying about the constraints of the existing hard wiring. The hard wiring aspect is taken care of by the Partitioning aspect. The weaver 36 receives the user input, determines the best way to implement it by taking the Partitioning Aspects into account, and generates appropriate code images for the affected hardware components. This separation of the aspects makes the system 10 efficient and easy to use.

New aspects can be easily added to the system because of the simple way in which propagation and selection are specified. The actual semantics of how the annotation will modify compilation is slightly more involved and requires adding the requisite modules to be added to the compiler. The compiler itself is structured to accommodate these new annotations in order to support an evolution of the all the possible aspects within the system.

The input aspect specification to the AOP system 30 is based upon a hierarchical description of the physical process that is being automated. Based on the Functionality aspect specification received from the user and the Partitioning aspects 34, the weaver 36 generates code images and partitions. A code image 37 is generated for each RFID router, and a code image 38 is generated for each individual network management computer 20. Where there are multiple layers of network management computers, a code image 38 is generated for each network management computer in the “pyramid” of computers.

An aspect specification can be thought of as a collection of annotations around a core syntax tree. The semantics of the individual aspects determine how the annotations are propagated around the core syntax tree. The core syntax of the AOP specification is a tree-specification of the physical spaces in the process. These spaces are referred to as zones. The core syntax specifies a tree of zones. An embodiment of this syntax is as follows:

Zone::=(Zone-name (Zone*))

Zone-Name::=“[text-character]+”

Each of the Aspect specifications are built around elements specified in this core syntax. For example, for the network hierarchy aspect, the hierarchy of networking elements is mapped onto this zone-tree (henceforth called the Physical Layout). What the aspect specification needs to yield, is a complete description of which zone is mapped to which network element (i.e., a networked computer). In one embodiment of this mapping, this is achieved by providing a sub-tree selection function and a propagation function. The sub-tree selection function selects a sub-tree from the Physical Layout and the propagation function propagates network-hierarchy information along this sub-tree. The network hierarchy aspect is then simply a syntactic specification of the selection and propagation functions. The semantics of this syntactic specification are provided by the compiler.

One embodiment of the syntax of sub-tree selection is 1 Zsexp::=(Zone-name*)(shallow-subtree of Zsexp) (deep-subtree of Zsexp) (with-property P Zsexp)

where P is a function in a programming language. In the system 10, this programming language is Scheme. Other methods of specification are possible, such as tree regular-expressions, etc. This sub-tree selection syntax is applicable across all the aspects, enabling a uniform way to deal with aspects. The compiler provides a few built-in propagation functions: Attach, Attach-with-inheritance and Attach-with-synthesis. The Attach function simply attaches the same annotation to each node. Attach-with-inheritance computes the annotation based on the annotation assigned to the parent of the node. Attach-with-synthesis computes the annotation based on the annotations assigned to the children.

The same scheme may be used to specify all aspects. An aspect specification, therefore, is a collection of sub-tree selection and propagation functions that propagate specific annotations.

The network-hierarchy aspect uses the Attach-with-synthesis function to assign network-element annotations. If all the children of a given zone are on the same network element, then that zone is assigned that network element. The propagation is iterated over-and-over until a fixed-point is reached. With this method of aspectual specification, new aspects can easily be added to the system.

Compilation

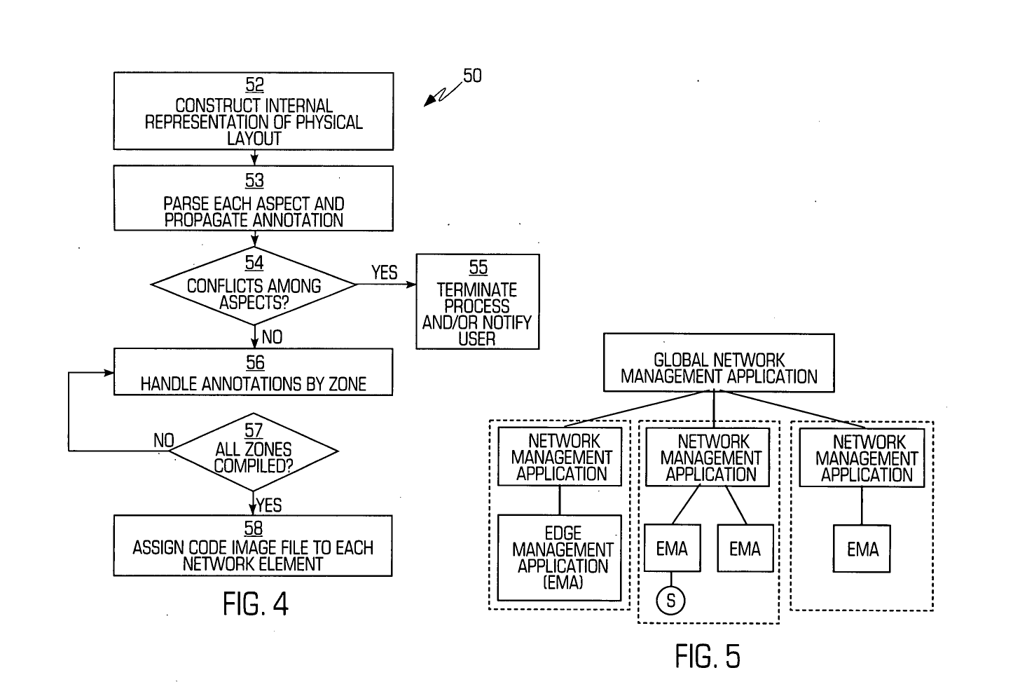

FIG. 4 is a flow diagram depicting the compilation and code generation process 50 performed by the AOP engine in the Network Management Computer. The AOP engine compiles the data by constructing an internal representation of the Physical Layout (step 52). Then, each of the Aspect specifications is parsed and the annotations are propagated (step 53). If there are any conflicts that get generated by different aspect specifications (step 54), these conflicts are reported and the compilation is terminated (step 55). Once all the annotations are propagated, each zone is compiled into a “zone-handler.”

Each zone handler is responsible for handling all the processing related to the relevant zone. This processing begins with managing RFID readers and other devices in the zone, going on to handling events that are generated by these devices and other processes that occur in the zone (such as timers, etc.). These events are handled according to the annotations that were placed on the zone by various aspects (step 56). For example, the system health aspect will cause the zone to record events coming from devices according to a system health criterion, but the Functionality Aspects will require the event to be treated as a decision making unit for overall semantics of the system.

Once the system has compiled all the zones (step 57), code is generated. Each network-element in the system is assigned a Code Image file (step 58). The Code Image file contains code for each zone that resides on that network-element. The Code Image file is generated as a source code, then compiled by traditional means to generate binaries that are distributed to each network-element during boot-up.

System Boot-Up and Operation

The distributed system includes a “code distribution” module that is also a network element. When it boots up, it looks up and loads the code image that corresponds to it. Once it is up and running, other network elements can connect to the code distribution module and download their respective code-images. The code-distribution server can selectively ask other network elements to reload code-images if they have changed (due to network or system upgrades). The network elements have a discovery protocol for discovering the code distribution module. Since any newly added network element will be updated by reaching the code distribution module with the discovery protocol, new network elements can be added without pre-configuration.

The code distribution module does not have to be started before other network elements. If other network elements start running first, they will hunt for an available code distribution module until one gets started. Some network elements may be capable of caching the code images. The code distribution server will only send them a new image if it has been updated. In this way, the entire network boots up and configures itself to carry out the functionality that is expected from the fully annotated Physical Layout tree.

Once the system is up and running, the execution expected by each of the individual aspect specification occurs through the coordinated interoperation of the zone-handlers in each network element. For example, system health monitoring is done by heartbeats that are propagated along the network hierarchy. This system health behavior can be modified by changing the aspect specification to require new information to be computed and propagated.

Inter-zone operation is handled by exchanging events between zones. Each zone queues events that will be handled by the zone handler. Network elements can assign events to these queues through a network protocol. Due to the layout of the distributed system being known at compiling, each network element has information about what is being executed in the other zones, and it is possible to route events directly to a chosen network element to achieve the inter-zone operation. This mechanism is used, for example, to send system health information to its immediate parent in the network hierarchy, as required by the system health aspect.

When the changes to the system are drastic, the entire network is restarted and all network elements will download the new code images from the code distribution module.

User Interface

Referring back to FIG. 1, the system 10 includes a graphical user interface 22. A central computer (not shown) contains data and computer instructions/software modules associated with the RFID system 10. The system 10 may further include a web server connected to the central computer that allows the graphical user interface 22 to act as a web-based user interface. The RFID system 10 may be set up and configured (based on the elements shown in FIG. 1) through the web based graphical interface through which the user specifies the attributes for the different aspects of the system. For example, the user may set up and configure the physical components (readers, routers, network management computers) of the network according to their individual needs. The user may also specify a logical partitioning (into zones) of the network and establish a hierarchy as determined by their solution and map it on the physical infrastructure. Once the zones are established, the user may define actions and operations wherein the actions and operations may be defined, created and installed on a zone-by-zone basis. This is further facilitated by the provision of a set of predefined behaviors representing some of the common tasks expected in RFID systems and available through the web-based graphical interface, such as monitoring of shelves and dock-doors but not limited to them. Additional behaviors can be quickly developed.

Further, the operations and actions can also be specified using the web-based graphical interface 22. For example, the user may specify the processing of data, the creation of and assignment of conditions to be monitored, the conditions related to data or patterns of data, the conditions related to the operation of any of the devices in the system (health management), the chaining of conditions and events to form more complex sequence of operations and the composing them further such that the final solution can comprise of different dependent processing components which are distributed over the network.

This (web based) user interface 22 also allows the user to quickly enhance their network by adding new components and/or modifying existing ones. A number of additional functions such as automatic health management of the infrastructure, data health management, and information about network characteristics can also be centrally/globally specified. These additional functions and information result in a more robust and a more efficient system operation. The user can, through this interface, observe the operation of the system, probe different aspects of it, and modify operational parameters of individual components or modify parameters of zones or even make global changes.

At the outset, a user has a set of requirements or expectations in terms of performance. The RFID infrastructure can be used to monitor and observe whether they are being met. Unexpected or incorrect operation can be detected and flagged. Observations can be recorded through logging pre-specified information (raw, event statistics etc) and notifications can be enabled. The notifications can be configured to be one or more of logging, email alert, page alert, alarms or exceptions among others. Examples of such applications are, on time performance, looking for defined patterns/distributions (statistics), or regulatory processing. Notification can be the triggering of different levels of alarms when violations or anomalies are detected.

Once the ability to detect events of interest exists, the user may wish to enhance the system to speed up response to anomalous situations. In order to analyze the anomalous or exceptional behavior, additional information relevant to the resolution of the anomaly/exceptional behavior may be needed. This collating of events and contextual data is then made available to the resolving entity for speedier problem resolution. Hence the notification incorporates report generation by culling relevant data from the enterprise (which may be obtained by querying various databases, internal and/or external) and formatting it in support of resolution, possibly with recommendations/hints and forwarding it to the relevant decision makers (humans or software). Enabling the appropriate record keeping helps generate business intelligence at a high resolution.

Using the high-resolution business intelligence, the user can build a more responsive system by automating the more frequent cases based on the resolutions applied at the previous level. This way, the system can evolve in terms of the type of data logging and exception detection to using additional relevant information and finally to making decisions. Iteratively, in this fashion, the user automates away into the normal flow of the business process what were earlier exceptional or anomalous behaviors and hence minimizes human intervention as time goes by.

The goal can be viewed as that of maintaining a certain state by observing certain parameters and responding to changes in them. Other examples of automatically closing the loop include triggering response actions (automatically generating and issuing purchase orders when inventory levels drop below threshold).

This is accomplished by providing the user with the means to define metrics for performance evaluation of their systems and then using the same event processing infrastructure to keep track of performance data. For example, the inputs to the performance evaluation system are the exceptions representing failures in the business process flows. The user can define counter-behaviors and assign them to assertions in different parts of their workflow/schema. A periodic log of the state of the counters is kept to create a performance history. This history can be post-processed to isolate problems and develop refinements. A similar approach can be used to monitor the health and status of the infrastructure. A similar process can be applied to diagnostics and debugging.

An exemplary implementation of the user interface 22 will now be described. The exemplary web-based GUI consists of the System Status Dashboard and the Customization Interface. The System Status Dashboard is the first page that opens after a user logs in. In a preferred embodiment, the system status dashboard may have three panes including a network status pane, an inventory search pane and a query results pane. The Network Status pane has status information on the network elements, such as NMAs, Routers and Sensors. If any of these elements is down, it flashes a system alert. A click on the pane shows the network status table. The Inventory Search pane shows the current inventory status in a table format. The user can search for inventory by Name or by EPC tag, or do an SQL Query.

When the user clicks on a ‘Customize RFID’ button on the System Status Dashboard page, a Customization Interface is opened in a new window. The Customization Interface is used to set up the RFID installation interactively. On the Customization Interface page there are 5 panes, which are described below:

The CONFIGURATION ICONS pane shows tabbed view of objects that can be manipulated to create the RFID installation. Icons for Objects (Distribution Center (DC), Dock door (DD), shelf), Behaviors (eg. Debug, Mature Data Set) and Devices (RFID Reader) are provided. These icons can be dragged and placed in the layout pane to create new instances of objects, behaviors and devices.

The ZONES pane shows the hierarchy of zone names starting from the root zone, which is the complete RFID Installation. The hierarchy is shown in a tree format. A single click on any zone name in this pane opens up the zone in the layout pane and a right click opens up a menu.

The LAYOUT pane shows the physical layout when a zone is opened. It has information about where each object is placed. Objects can be dragged and placed in the zone layout. Objects added to this zone show up as icons. Each icon can be double-clicked and opened out in the layout pane. A right click on the icon opens up a menu.

The PROPERTIES pane shows the name, behaviors and their parameters for the opened object.

The HELP pane shows context sensitive help.

The web-based GUI may also include a tool bar. The toolbar may have the following button: Clear, Undo, Refresh and Update. The clear button clears the physical layout of the opened object, the undo button permits the most recent clear or delete operation to be reverted. The update button updates the server with the current configuration and then it restarts the server and passes the new script to all the clients that are connected to it. The web-based GUI may also include a status bar that shows the names of icons, if the user places the mouse over them. Now, the aspect oriented server of the system will be described in more detail.

Query

The system may also include a real-time query processing system. The query function is usually started by selecting a Query option on the web-based GUI screen. A separate results pane may show the results of the query. The query option allows the user to query the system or user-selected parts of the system. Some queries are responded to immediately (e.g., report what is visible in zone X) while other queries are “persistent” (e.g., report the next time event Z happens). Queries can address the data or the state of the system. They may access process/workflow profiling data to assist with debugging.

To set up an exemplary system/network, a sequence of steps may be performed. In particular, objects from the Configuration Icons pane of the user interface can be dragged and dropped to the Layout pane. The objects may come with certain default behaviors. Next, a DC from the Objects tab is first dragged and placed in the main window. Many such DCs can be placed in different geographical locations nationwide. Each DC comes with a default NMA behavior, which associates it to a particular IP address and location. Then, DDs and shelves can be added to the DC. These objects similarly come with a default Router behavior. Next, readers can be added to the DDs and shelves. These readers automatically detect the router and the port to which they are connected. As the objects are added to the Layout pane, their names get added to the Zones pane and the entire hierarchy can be seen in this pane. Clicking any zone name in this pane, opens it in the Layout pane. Behaviors are added next and they show up as icons in the behavior panel. The behavior panel shows all the behaviors for the opened object. One behavior may depend on other behaviors. If a behavior has certain parameters, a window pops up waiting for the user input. For example, if a Mature Data Set Behavior is added to a DD, the user can enter the maturation delay. A right click on the icon opens a menu, which allows the user to edit parameters for that behavior. Once a DC is set up, it can very easily be managed. The right click menu on each object has copy, paste and delete features. The most powerful feature is the ability to replicate objects. For example, once a DC is set up, it can be copied and pasted at different locations. Thus, it is very easy to move from a pilot installation to a full-scale production.

Business processes tend to be complex and dynamic operations. Thus, it is important for it to be implemented in a system that can evolve with the changing needs. The user can utilize the capabilities of RFID system 10 to progressively improve their insight into the business processes, which then can be applied to create improvements and increase the value that they can accrue from such a system.

The exemplary RFID system shown above may include an on-demand upgrade system for downloading upgrades and/or updates to elements or components of the RFID system (e.g., network management computers, RFID routers, sensors). The upgrade system now described, however, is not limited to the particular RFID system shown above and can in fact be implemented for various distributed systems in which it is desirable to be able to upgrade one or more components of the system in an efficient manner.

Returning to the exemplary RFID system, the system can include heterogeneous components arranged in multiple network layers over multiple domains. For example, sensors can include RFID tag readers, GPS devices, temperature sensors, pressure sensors, etc. These components may be distinct from one another, and upgrades and/or updates (hereafter collectively referred to as upgrades) to augment functionality of the components may apply to a specific component or a class of components. In addition, certain components within a class of components might already be up to date. Consequently, a massive upgrade push from the network center—e.g., transmitting the upgrade to all downstream components—may be impractical or impossible depending upon the arrangement of the RFID system.

Furthermore, a massive upgrade push can inefficiently consume valuable network resources. Consider the following example. An upgrade is made available for RFID readers at the network center. If the upgrade is subsequently pushed through the network, the upgrade may need to be transmitted to each network layer, to each domain, and to each component. Components that do not need the upgrade (e.g., components that are distinct or are up to date) may ignore it while those that require the upgrade can be upgraded accordingly (e.g., via the network management computers and/or RFID routers). However, a particular domain may have few or no RFID readers, and many of the components in the network may not be RFID readers. As a result, network resources (e.g., storage, bandwidth, processing cycles) may be consumed in transmitting the upgrade software to domains and components that do not need it. In contrast, the on-demand upgrade system ensures that only those components which require the upgrade receive it, increasing the overall efficiency of RFID system and reducing operational costs.

FIG. 5 illustrates another exemplary distributed system 100 that may include an upgrade system and method. As described above, this system can be any distributed system with multiple components at multiple levels where it would be desirable to provide an efficient mechanism for upgrades one or more components or a class of components of the system using the upgrade system. In the example in FIG. 5, a sensor system is shown that may be an RFID system such as that shown in FIG. 1 above. The distributed system has a global network management application 110, that may be implemented as a piece of software executing on a computing device, such as a server computer, that manages the overall operation and functioning of the system. The system may further comprise one or more regions 112, such as a first region 112₁, a second region 112₂ and a third region 112₃ wherein each region in this example corresponds to a geographical region in which the system performs its operations. Within each region, the system may include a network management application 114, that may be implemented as a piece of software executing on a computing device, such as a server computer, that manages the operation and function of the system within the particular region. Furthermore, each region may have one or more edge management applications 116, that may be implemented as a piece of software executing on a computing device, such as a server computer, that manage the operation and functions of one or more sensors 118 that are coupled to the edge management application. In this system, the operation of the system, such as a sensor network or RFID network, is managed by the various applications at the various levels of the system architecture. As with exemplary RFID system, the components of the system (e.g., the various sensors of the system as well as the various management applications are not homogenous and therefore a massive code upgrade push technique does not work effectively for such as heterogeneous system. Now, a method for performing the upgrade according to the upgrade method will be described.

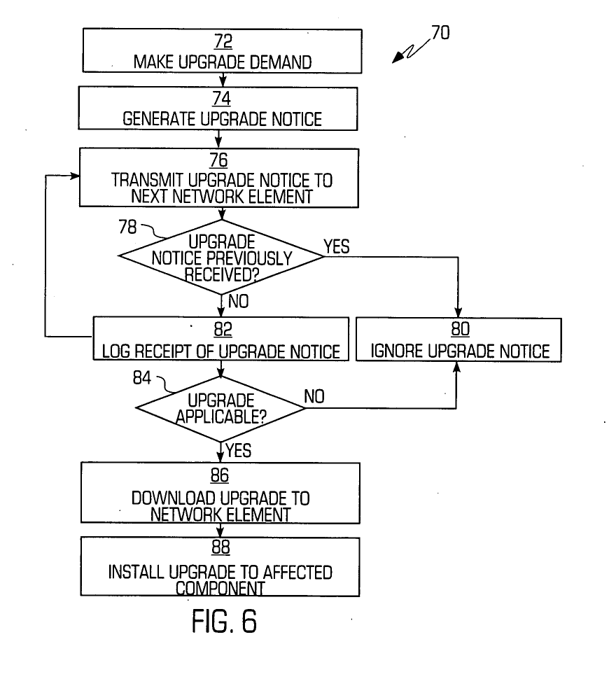

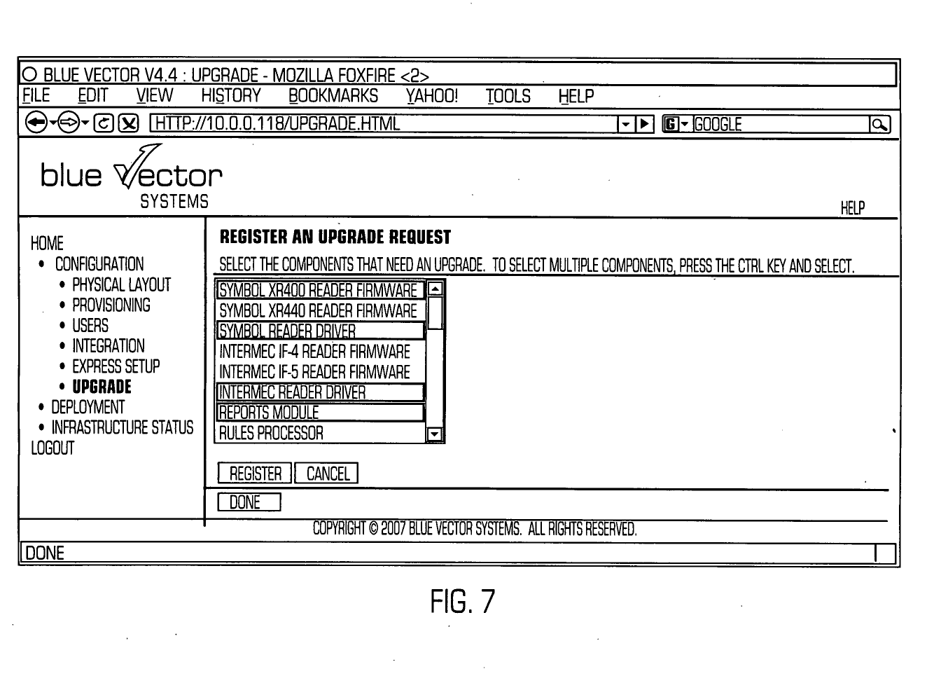

FIG. 6 is a flow diagram depicting a method 70 for an on-demand upgrade system. In the distributed system shown in FIG. 5, configuration information for each sensor/component is stored in a code image at the sensor/component. An upgrade demand is made at the network center/global network management application using the web-based GUI to upgrade specific elements or components of the network (72) as shown in FIG. 7 wherein the user can select one or more components that require an upgrade and then register the upgrade. For example, a upgrade to a Symbol® type of sensor may be registered with the global network management application and the system therefore needs to upgrade the code image of any Symbol® type of sensor within the system without undue network activity delivering the upgrade to network management applications and/or edge management applications that do not manage any Symbol® type of sensors. It should be understood that each element of the system knows which other elements and components are underneath the element in the network. The on-demand upgrade system also may be operated by a user-friendly web-based GUI that may be remotely accessible by an out-of-network computer system. For example, the network can include a web server connected to a central computer that allows a remote user to connect to the network with the central computer may include computer instructions or software pertaining to the on-demand upgrade system. For example, the previously described user interface may include a separate Upgrade pane, or the Network Status pane of the System Status Dashboard and the Customization Interface might include an upgrade function implementing the system. The on-demand upgrade system can also be a graphical user interface that is separate from user-interface, and function as a stand alone upgrade program. Access to the on-demand upgrade system can be controlled to preserve the integrity of the network, while still enabling flexible network management and observation from off-site or out-of-network locations.

Instead of the upgrade demand being made to the system as described above, the upgrade demand may be automatically generated by the system. For example, the upgrade unit of the overall system may be configured to periodically check an out-of-network location to determine whether new upgrades are available and to generate an upgrade demand accordingly. In all cases, the upgrade demand includes an identification of the upgrade software and its location, the affected class of components, and/or affected network layers or domains. The upgrade demand might also include downloading the appropriate upgrade software to the network center—for instance, to a storage associated with the central computer, or to a storage dedicated to upgrade software—or the upgrade software may already exist on the network. In addition, a more sophisticated on-demand upgrade system can be implemented that includes additional upgrade options; for example, the system may identify out-of-network locations where upgrade software can be found (e.g., at a third-party vendor or developer web site), additional upgrade conditions (e.g., scheduling, logging, version, related-component upgrades, etc.), recurring upgrades, or the length of time the upgrade software is retained in storage. The on-demand upgrade system is robustly adaptable, and those with skill in the art will recognize that the capabilities of the system can be varied according to the requirements of a particular network and RFID system.

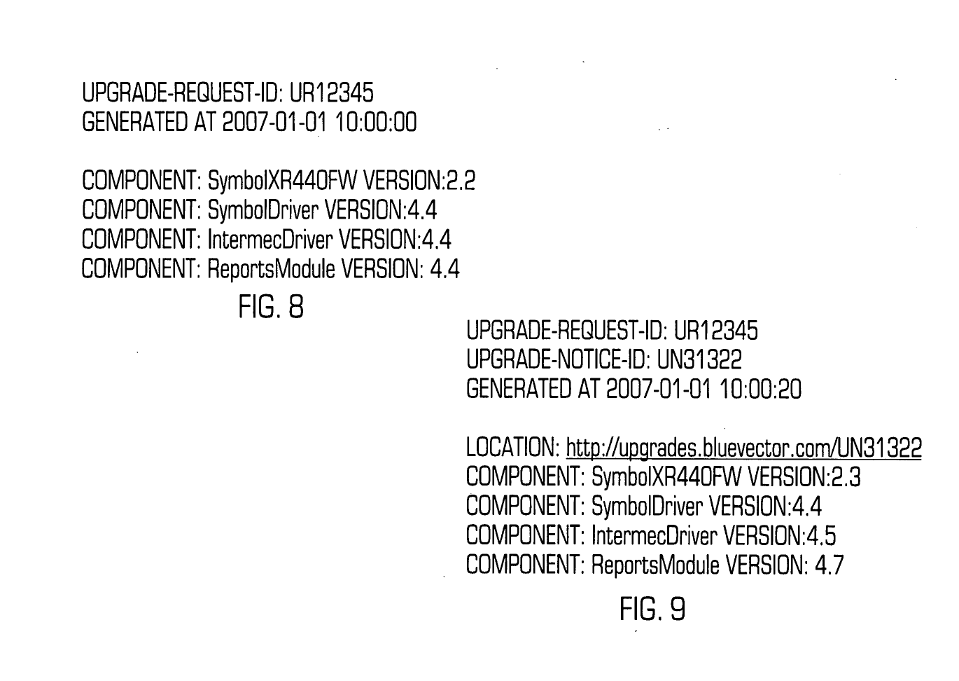

Returning to FIG. 6, in response to the upgrade demand, the on-demand upgrade system (implemented as a plurality of lines of code executing on the computing device that executes the global network management application in an exemplary embodiment) generates an upgrade notice including information regarding the affected components (e.g., the types of components for which the upgrade is intended which is specified by the upgrade request) and the location of the upgrade software (74). FIG. 8 illustrates an example of an upgrade request of the system and FIG. 9 illustrates an example of an upgrade notice generated by the system.

Unlike the actual upgrade code/image, the upgrade notice is a very lightweight, compact message that does not consume significant network resources so that it can be circulated through the network without the overhead of transmitting the entire upgrade code image. Thus, the upgrade notice is configured so that it may be efficiently propagated through the network without consuming a significant amount of network resources, and so that network elements can easily identify the upgrade. To propagate the notice, the upgrade notice is transmitted to a network element (e.g., a network management computer/application, edge management application or RFID router), such as an element located in the next network layer (76) so that the upgrade notice is communicated to each level of the network system (from the top down) so that each component at each level of the network is made aware of the upgrade. Each component of the system that receives the notice and performs the upgrade process described below may include an upgrade unit, that may be implemented in an exemplary embodiment as a plurality of lines of code executed by the processing unit that executes the software of the component or as hardware in the computing device of the component, that executes the upgrade process described below. Alternatively, the upgrade process may be communicated to each component as part of the upgrade notice. Thus, the upgrade unit in the particular element then checks the upgrade notice to determine whether it has previously received the same upgrade notice (78). If the particular element has previously received the notice, it ignores the upgrade notice (80) and the upgrade process for that particular element is completed. If the particular element has not previously received the notice, the element logs receipt of the upgrade notice (82) and then transmits the notice to another network element (76) so that the notice filters down through the entire system and network.

When the particular element logs the upgrade notice, the upgrade unit checks the upgrade notice to see whether the upgrade demand applies to the element itself, or to any component associated with the element (e.g., sensors connected to an RFID router in the RFID system example) (84). If the upgrade is not applicable, the upgrade unit ignores the upgrade notice (80) and the upgrade process for that element (and the components connected to that element) is completed. If the upgrade is applicable to the element or a component coupled to the element, the element uses information provided in the upgrade notice to locate and download the upgrade software (86). Thus, the actual upgrade software is only transmitted from the top of the network down to components for which the upgrade is applicable thereby minimizing the network traffic during the upgrade process. The network element then installs the upgrade to itself or an associated component (88).

The manner of the download also may be conditioned by the upgrade demand. For example, the upgrade demand might indicate a time period when the upgrade should be downloaded, such as during a period of low network activity. The upgrade may require related upgrades; for instance, an upgrade might require that a network element, such as an RFID router, also be upgraded along with the specified component, but only if the specified component is associated with that particular router. These conditions can be reflected in the upgrade notice. Thus, the on-demand upgrade system may be used to selectively upgrade network components and related components without requiring separate identification of each affected component, improving overall efficiency and operation of the RFID system. The system allows the upgrade demand to be tailored to a particular RFID system, network, and business application.

Each component/element of the system or network that receives the upgrade notice also may be configured to report receipt of an upgrade notice to a master upgrade log so that the system is able to determine when the upgrade notice has been fully propagated through the network. Each component/element may also be configured to periodically check the master upgrade log (or a separate log) to determine whether there are current upgrade demands to be completed. This function may be included in a self-healing aspect of the network element; for instance, so that a particular node or domain does not miss an upgrade demand if it is temporarily down or disconnected from the network. In this way, the on-demand upgrade system is able to efficiently identify those components of the system, such as the exemplary RFID network, that requires the upgrade without consuming valuable network resources by transmitting the upgrade to the entire network. The system can further conserve network resources by reducing or eliminating the need for network elements to regularly contact a central computer to check for new upgrades. Furthermore, the system allows for on-demand upgrades by allowing a user to initiate an upgrade at any time. This is in contrast to other upgrade systems where network elements contact an upgrade server and upgrade at regularly scheduled times, such as during boot, and do not respond immediately to an upgrade demand.

As an alternative to the process described above in which the upgrade software is downloaded to each component/element as needed, the upgrade system may also download the upgrade software to network elements or to storage in the affected domains. For example, a network management computer in an affected domain for the RFID exemplary system may contact the network center (or upgrade storage) and download the upgrade software. The RFID routers connected to components that require the upgrade can then download the upgrade from the network management computer. This way, the network center is not flooded with download requests from multiple RFID routers in response to an upgrade demand. In large RFID systems, the upgrade demand may schedule different download times for different domains (e.g., the upgrade notice may specify that Tokyo domain is to download an upgrade, if required, at a certain time, while San Francisco domain is to download an upgrade, if required, at a different time). Alternatively, the RFID routers may download the upgrade software independently from the network management computer. As discussed previously, different upgrade demands may impose different download conditions in a single RFID system; thus, one upgrade demand might have the network management computers download the upgrade, while another upgrade demand might have the RFID routers download the upgrade.

To install the upgrade software in the exemplary RFID system shown above, the RFID routers may install the upgrade to the affected components, rebooting components as required to complete the upgrade. The network management computers may alternatively install the upgrade directly to affected components, bypassing the RFID routers, depending upon the configuration or needs of a particular system. Upgrades which affect network elements may be installed directly to those elements. For example, an upgrade downloaded to and for a network management computer may contain self-executing code so that the network element can install the upgrade itself. Upgrades to the RFID routers may occur in a similar fashion, or may be executed or managed by the network management computer. The upgraded network elements may be rebooted, as required, to complete the upgrade. The network elements may then generate and send an additional upgrade log report indicating the upgrade, the affected components, any technical issues or problems that may have occurred during the upgrade, as well as other performance and system status information.

To better illustrate the on-demand upgrade system, an example of the upgrade process for an RFID network is described. In this example, an out-of-network user connects to the central computer via the world wide web and initiates an upgrade demand using the web-based GUI. The user specifies in the upgrade demand that the upgrade is for all type A humidity sensors in the network, with a related upgrade for all RFID routers with type A humidity sensors. The user further indicated that the upgrade should be immediate, and uploads the upgrade software to an upgrade storage associated with the network. The on-demand upgrade system generates an upgrade notice in response to the upgrade demand, indicating the upgrade (for all type A humidity sensors), related upgrade (RFID routers with type A humidity sensors), that the upgrade is immediate, and the location of the upgrade software. Assuming that the network in this example comprises two domains, a Tokyo domain and a San Francisco domain. The network center transmits the upgrade notice to both domains. A network management computer for the San Francisco domain receives the upgrade notice and checks an upgrade log to determine whether it has previously received the same upgrade notice. It has not, and logs receipt of the upgrade notice. It also sends a return notification to a master upgrade log indicating that it has received the upgrade notice. The San Francisco domain has no child domains, so it does not transmit the upgrade notice to the next network layer. The network management computer then determines based on the contents of the upgrade notice whether any associated components in the domain require are affected by the upgrade demand. The San Francisco domain does not have any associated humidity sensors, and thus disregards the upgrade notice. A network management computer for the Tokyo domain similarly receives the upgrade notice, checks an upgrade log, and determines it has not previously received the same upgrade notice. It logs receipt of the upgrade notice and sends notification to the master upgrade log. The Tokyo domain has no child domains, and does not transmit the notice to the next network layer. The network management computer determines based on the contents of the upgrade notice that some sensors in the domain are affected by the upgrade notice. For example, assume the Tokyo domain includes an RFID router with type B humidity sensors and an RFID router with type A and type B humidity sensors. The network management computer contacts the upgrade storage and downloads the humidity upgrade software and related upgrade software. The network management computer then installs the upgrade software to the type A humidity sensors, and the related upgrade software to the affected RFID router. The network management computer then sends an additional notification to the network center indicating those type A sensors that have been upgraded, as well as the RFID router, and other upgrade related technical information. Thus, aspects of the RFID system have been upgraded using the on-demand upgrade system.

The on-demand upgrade system may also be implemented in an RFID system that includes only one type of sensor (e.g., RFID readers), and is not limited to heterogeneous systems. The system may also be implemented in a system including only one type of sensor, but where the sensors may be from different manufacturers or incorporate legacy technology. Thus, the on-demand upgrade system is robustly adaptable, enabling flexible RFID system and network maintenance from off-site or out-of-network locations. The on-demand upgrade system acts as a general upgrade engine for the network, allowing a user or the system to identify and upgrade only those components or network elements in a heterogeneous RFID system that require upgrading. The on-demand upgrade system uses minimal network resources, contributes to the overall efficiency of the RFID system, and reduces operational costs. The system is adaptable to a variety of RFID systems and can evolve with changing needs. The on-demand upgrade system thus facilitates management of the entire supply chain in a complex and dynamic business or operation. A user can utilize the capabilities of the on-demand upgrade system to progressively improve operation of the network, which can then be applied to create improvements and increase the value of the overall business or RFID system.

While the foregoing has been described with reference to a particular embodiment, it will be appreciated by those skilled in the art that changes to the embodiment may be made without departing from the principles and spirit of the invention.

What is claimed is:

1. A system for upgrading components in a network, the network having one or more domains and one or more components within each domain, the system comprising:
a first network management unit that receives an upgrade demand identifying an upgrade, a component affected by the upgrade and an upgrade, the first network management unit configured to generate a upgrade notice based on the upgrade demand wherein the upgrade notice requires less bits than the upgrade demand;
one or more second network management units coupled to the first network management unit, each second network management unit having an upgrade unit wherein the upgrade units are configured to receive the upgrade notice;
one or more components coupled to each of the second network management units; and
wherein each upgrade unit is configured to identify any of the components coupled to the upgrade unit affected by the upgrade notice, to download the upgrade software and to install the upgrade to the components affected by the upgrade notice to propagate the upgrade through the network using the upgrade notice.

2. The system of claim 1, wherein each upgrade unit is configured to ignore the upgrade notice if none of the components coupled to the upgrade unit are affected by the upgrade notice.

3. The system of claim 1, wherein each upgrade unit further comprises a computing device having a processing unit and a plurality of lines of computer instructions that are executed by the processing unit of the computing device.

4. The system of claim 1, wherein the upgrade is a software upgrade and wherein each component further comprises a device having a piece of software executed on the device wherein the piece of software is upgraded using the software upgrade.

5. The system of claim 1, wherein the first network management unit further comprises an network upgrade unit and an upgrade notice log that contains a record of each upgrade demand wherein the network upgrade unit is configured to ignore a newly received upgrade demand that is already contained in the upgrade notice log.

6. The system of claim 1, wherein the upgrade notice includes a download location of the upgrade and the upgrade unit is configured to download the upgrade from the download location included in the upgrade notice.

7. The system of claim 1 further comprising an upgrade storage that stores the upgrades received by the system and wherein the update unit is configured to download the upgrade from the upgrade storage.

8. The system of claim 1, wherein the upgrade notice further containing upgrade instructions including one or more of a download scheduling instruction, a conditional upgrade instruction, an upgrade logging instruction, and a recurring upgrade instruction.

9. The system of claim 1, wherein the upgrade notice had an identification of a class of components that are affected by the upgrade demand.

10. The system of claim 1, wherein the upgrade unit is the affected component on which the upgrade is installed.

11. The system of claim 1 further comprising a remote computing device coupled to the first network management unit, wherein the remote computing device is configured to provide a user interface that received the upgrade demand.

12. The system of claim 11, wherein the computer is connected to the first network management unit through the world wide web.

13. The system of claim 1, wherein the first network management unit is configured to provide a user interface to receive the upgrade demand.

14. The system of claim 1, wherein the first network management unit further comprises an network upgrade unit that is configured to automatically detect the upgrade demand.

15. A system for upgrading network components in a network, comprising:
a plurality of network components each having one or more pieces of software executed on the network component;
a plurality of network management elements in communication with the plurality of network components that install software to the plurality of network components;
a network upgrade unit configured to accesses an upgrade program stored on the network, the upgrade program including a user interface for receiving a user upgrade demand requesting an upgrade to the one or more pieces of software of the network components, an identification of network components affected by the upgrade, the upgrade program including a notice function that generates an upgrade notice containing upgrade instructions; and
wherein the upgrade notice is transmitted to the plurality of network management elements and one or more of the plurality of network management elements downloads an upgrade software and installs the upgrade software to the affected components based on the upgrade instructions.

16. The system of claim 15 wherein the upgrade notice is transmitted in the network from one network management element to another network management element.

17. The system of claim 16, wherein each network management element receives the upgrade notice and determines if one or more network components associated with the network management element is an affected component based on the upgrade instructions.

18. The system of claim 17, wherein each of the plurality of network management elements having an upgrade notice log containing a log of upgrade notices transmitted in the network and received by the network management element, and wherein each of the plurality of network management elements receives the upgrade notice and logs for the upgrade notice in the upgrade notice log if the upgrade notice log does not contain a log of the upgrade notice, or ignores the upgrade notice if the upgrade notice contains a log of the upgrade notice.

19. A method for upgrading components in a network, the network having one or more domains and one or more components within each domain, the method comprising:
receiving, at a first network management unit, an upgrade demand identifying an upgrade, a component affected by the upgrade and an upgrade;
generating, at the first network management unit, upgrade notice based on the upgrade demand wherein the upgrade notice requires less bits than the upgrade demand;
receiving, at an upgrade unit of one or more second network management units coupled to the first network management unit, the upgrade notice; and
propagating the upgrade notice through the system including the upgrade unit of one or more second network management units and one or more components coupled to each second network management unit wherein the upgrade demand and upgrade is not propagated through the system except for components to which the upgrade demand applies.

20. The method of claim 19, wherein propagating the upgrade notice further comprises identifying, at each upgrade unit, any of the components coupled to each upgrade unit affected by the upgrade notice, downloading the upgrade to the upgrade unit for the affected component and installing the upgrade to the components affected by the upgrade notice.

21. The method of claim 19 further comprising ignoring, at each upgrade unit, the upgrade notice if none of the components coupled to the upgrade unit are affected by the upgrade notice.

22. The method of claim 19 further comprising maintaining, at the first network management unit, an upgrade notice log that contains a record of each upgrade demand, and ignoring, at the first network management unit, a newly received upgrade demand that is already contained in the upgrade notice log.

23. The method of claim 19 wherein the upgrade notice includes a download location of the upgrade and wherein downloading the upgrade further comprises downloading the upgrade from the download location included in the upgrade notice.

24. The method of claim 19, wherein the upgrade notice further containing upgrade instructions including one or more of a download scheduling instruction, a conditional upgrade instruction, an upgrade logging instruction, and a recurring upgrade instruction.

25. The method of claim 19, wherein the upgrade notice had an identification of a class of components that are affected by the upgrade demand.
